(19) United States
(12) Patent Application Publication
(10) Pub. No.: US 2006/0005168 A1
(43) Pub. Date: Jan. 5, 2006

(54) Method and system for more precisely linking metadata and digital images

(76) Inventor: Mona Singh, Cary, NC (US)

Correspondence Address: IPAC, 111 Corning Road, Suite 220, Cary, NC, 27511, US

(21) Appl. No.: 10/884,395

(22) Filed: Jul. 2, 2004

(51) Int. Cl. G06F 9/44

(52) U.S. Cl. 717/123

(57) ABSTRACT

A method and system for associating metadata with an image is described. The method and system include allowing a portion of the image to be selected. The method and system also include associating the metadata with the portion of the image that has been selected. In another aspect, the method and system include displaying the image with a portion of the image being highlighted. The metadata is associated with the portion of the image. In this aspect, the method and system also include allowing the metadata to be played in response to the portion of the image being selected. Consequently, the metadata can correspond to a specific portion of the image, instead of the image in its entirety.

### FIELD OF THE INVENTION

The present invention relates to digital imaging devices and more particularly to a method and system for associating metadata with images.

### BACKGROUND OF THE INVENTION

FIG. 1 depicts a conventional image 10. Images are typically made up of elements. In the conventional image 10 shown, the elements include people 12 and 14, tree 16, and buildings 18 and 20. Other conventional images may include other and/or different elements. The conventional image 10 may be captured by an image capture device, such as a digital camera. In addition, the conventional image 10 is a digital image that is represented in digital form.

Often, metadata is associated with a conventional image. For the conventional image 10, the metadata 22 is depicted as being printed below the image 10. Such metadata may include sound, text, or other metadata describing the image. For example, in the conventional image 10, the user may wish to identify the people 12 and 14, the buildings 18 and 20, or the type of tree 16. In order to do so, the user may enter this information, for example in a text format. The metadata 22 is then associated with the conventional image 10. When the conventional image 10 is viewed, the metadata 22 associated with the image is provided. For example, the metadata 22 may be printed as text below the conventional image 10 as shown in FIG. 1.

Although the conventional image 10 and the associated metadata 22 allow the user to more fully describe the elements 12, 14, 16, 18, and 20 or other aspects of the image, one of ordinary skill in the art will readily recognize that there are limitations to the metadata 22. In particular, the metadata 22 may not adequately describe the conventional image 10. For example, in FIG. 1, the conventional metadata identifies the individuals 12 and 14 (Tom and Dick), as well as the buildings 18 and 20 (Tom's house and Dick's house) in the conventional image 10. However, a viewer who does not know Tom or Dick may be unable to identify the individuals solely on the basis of the metadata 22 provided. Further, even if the viewer does know the people 12 and 14, the viewer may be unable to tell which house is Tom's or Dick's based upon the metadata 22. The user who entered the metadata may be able to provide more specific metadata (e.g. Tom is on the left and Dick is on the right). However, this places a greater burden on the user and requires the user to more carefully choose the terms used in the metadata 22. Further, there may be limitations to the amount of text that can be provided in the metadata 22. As such, the user may not be able to sufficiently describe the elements 12, 14, 16, 18, and 20, or the entire image.

Accordingly, what is needed is a mechanism for allowing a user to better describe images. The present invention addresses such a need.

### BRIEF SUMMARY OF THE INVENTION

The present invention provides a method and system for associating metadata with an image. The method and system comprise allowing a portion of the image to be selected. The method and system also comprise associating the metadata with the portion of the image that has been selected. In another aspect, the method and system comprise displaying the image with a portion of the image being highlighted. The metadata is associated with the portion of the image. In this aspect, the method and system also comprise allowing the metadata to be played in response to the portion of the image being selected. Consequently, the metadata can correspond to a specific portion of the image, instead of the image in its entirety.

According to the method and system disclosed herein, the present invention allows metadata to be associated with specific parts of an image. Consequently, a user's ability to describe or otherwise customize features of an image is improved

### BRIEF DESCRIPTION OF SEVERAL VIEWS OF THE DRAWINGS

FIG. 1 is a diagram of a conventional image.

FIG. 2 is a high-level flow chart depicting one embodiment of a method in accordance with the present invention for associating metadata with an image.

FIG. 3 is a more detailed flow chart depicting one embodiment of a method in accordance with the present invention for associating metadata with an image.

FIG. 4 is a diagram of a portion of an image capture device in accordance with the present invention capable of associating metadata with a portion of the image.

FIG. 5 is a flow chart depicting one embodiment of a method in accordance with the present invention for displaying an image having metadata associated with a portion of the image.

FIG. 6 is a diagram of one embodiment of an image in accordance with the present invention having metadata associated with portions of the image and having all portions of the image corresponding to the metadata highlighted.

FIG. 7 is a diagram of one embodiment of an image in accordance with the present invention having metadata associated with portions of the image and having some of the portions corresponding to the metadata highlighted.

FIG. 8 is a diagram of one embodiment of an image in accordance with the present invention having metadata associated with a portion of the image selected and the associated metadata displayed.

### DETAILED DESCRIPTION OF THE INVENTION

The present invention relates to digital images. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for associating metadata with an image. The method and system comprise allowing a portion of the image to be selected. The method and system also comprise associating the metadata with the portion of the image that has been selected. In another aspect, the method and system comprise displaying the image with a portion of the image being highlighted. The metadata is associated with the portion of the image. In this aspect, the method and system also comprise allowing the metadata to be played in response to the portion of the image being selected. Consequently, the metadata can correspond to a specific portion of the image, instead of the image in its entirety.

The present invention will be described in terms of a particular image, a particular method, and a particular image capture device. However, one of ordinary skill in the art will readily recognize that the present invention can be utilized with other images, other devices, and methods having other and/or additional steps not inconsistent with the present invention.

To more particularly describe the method and system in accordance with the present invention, refer to FIG. 2, depicting a high-level flow chart of one embodiment of a method 100 in accordance with the present invention for associating metadata with an image. The method 100 may be implemented on a variety of systems. In one embodiment, the method 100 is implemented using an image capture device such as a digital camera. In such an embodiment, the user may be able to enter the metadata at around the time (e.g. either shortly before or shortly after image capture) that the image is captured. The method 100 might also be implemented later either on the image capture device or another device, such as a computer system, on which the user is viewing and/or editing the image. Further, although the method 100 is described in the context of associating metadata with a single portion of an image, the metadata may be associated with multiple portions of the image, or multiple portions of the image may be associated with different pieces of metadata.

The user selects a portion of the image with which the image is supposed to be associated, via step 102. For example, the user may select a particular element in an image such as an individual, a building, or another object in the image. The user might also select a particular region of the image in which multiple elements reside. In one embodiment, step 102 includes the user selecting a graphical element, such as a preset shape, or indicates that the user desires to outline the portion of the image with which the metadata is to be associated. For example, rectangles having sharp or rounded corners, ovals, circles, or other forms may be provided as preset shapes. Step 102 also includes selecting the size and position of the graphical element.

The metadata is associated with the portion of the image that has been selected, via step 104. In one embodiment, step 104 includes storing the metadata, or a tag directing the system to the metadata, with the x and y-coordinates of the image. In such an embodiment, the metadata is stored with particular x-coordinates and y-coordinates of the portion of the image selected. For example, if a rectangular graphical element is selected, sized, and positioned in step 102, then step 104 may include storing the metadata with the x-coordinates and y-coordinates of the rectangular graphical element. The metadata is also preferably associated with the portion of the image such that the portion of the image can be highlighted when viewed and/or printed. Consequently, the viewer of the image may be notified of the existence of the metadata. Step 104 also may include storing the metadata such that when the portion of the image is selected, the metadata is played. In one embodiment, the metadata is converted to html so that when a user moves a cursor or pointer over any part of the portion of the image, the metadata is played. For example, if the metadata is text or sound, the metadata may be displayed or heard, respectively, when the user passes a cursor or pointer over the portion of the image. Thus, the user is allowed to access the metadata.

Using the method 100, metadata can be associated with selected portions of the image rather than only the entire image. Consequently, the user can easily identify or describe regions or elements of the image. As a result, the user's ability to readily inform other viewers of the contents of the image is improved.

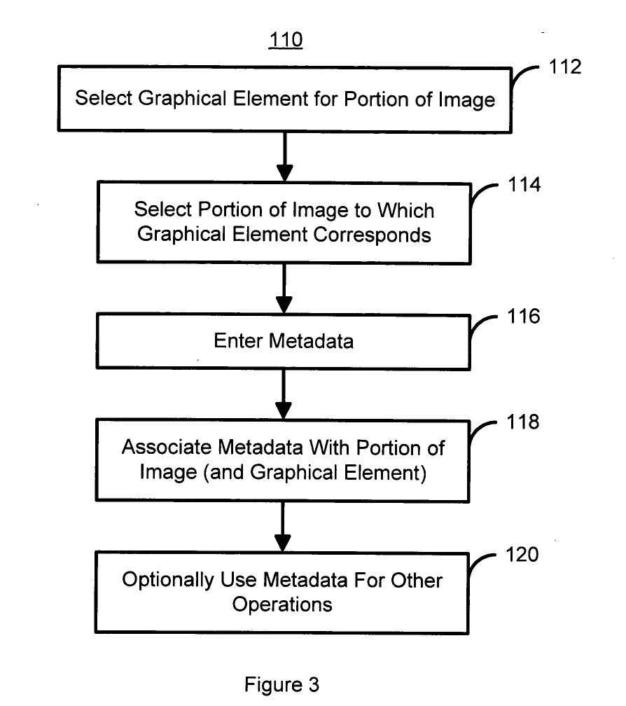

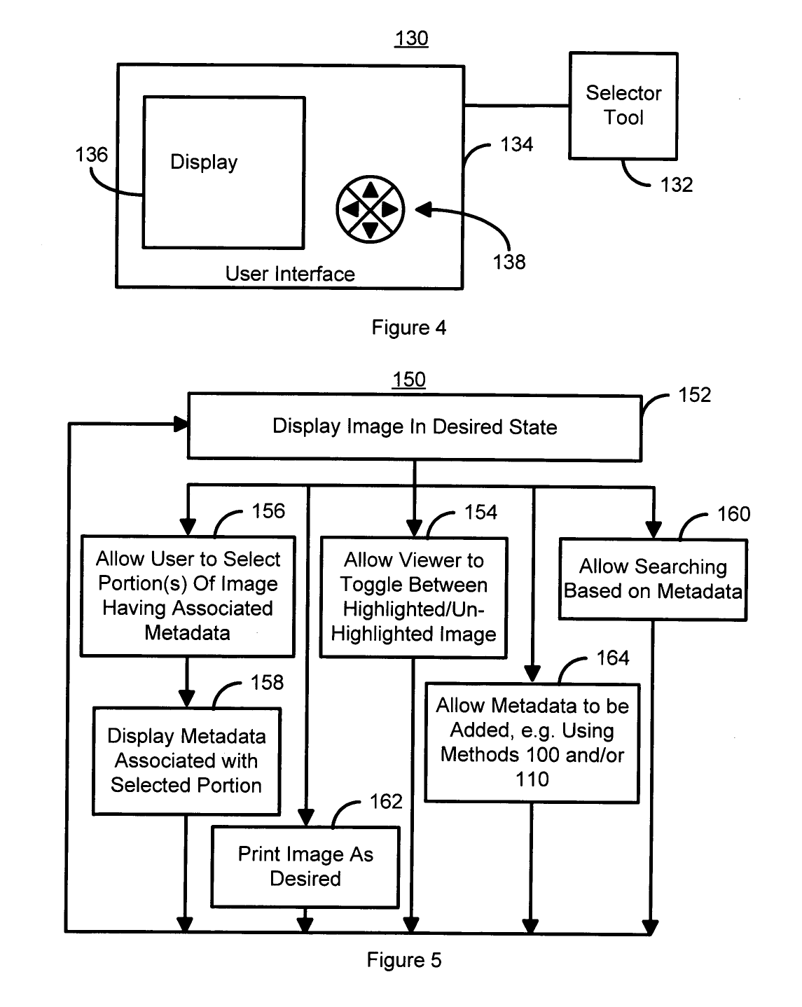

FIG. 3 is a more detailed flow chart depicting one embodiment of a method 110 in accordance with the present invention for associating metadata with an image. The method 110 may be implemented on a variety of systems. In one embodiment, the method 110 is implemented using an image capture device such as a digital camera. In such an embodiment, the user may be able to enter the metadata at around the time (e.g. either shortly before or shortly after image capture) that the image is captured. The method 110 may be implemented later either on the image capture device or another device, such as a computer system, on which the user is viewing and/or editing the image. FIG. 4 is a diagram of a portion of an image capture device 130 in accordance with the present invention capable of associating metadata with a portion of the image. The method 110 is described in the context of the image capture device 130. However, nothing prevents the method 110 from being used with another device. Further, although the method 110 is described in the context of associating metadata with a single portion of an image, the metadata may be associated with multiple portions of the image, or multiple portions of the image may be associated with different pieces of metadata.

The user selects a graphical element used in associating the metadata with a portion of the image, via step 112. The graphical element is preferably provided by the selector tool 132 that is accessed via the user interface 134. In particular, the graphical elements available may be selected from a menu depicted on the LCD screen 136. The graphical element may be a preset shape, such as a rectangle, oval, or other shape. For example, regular polygons with sharp or rounded corners might be used. A default shape, such as a circle or the last shape a user applied, could be provided. The user could then utilize the default shape or select an alternate shape. The graphical element may also allow the user to outline an arbitrary shape for a particular portion of the image with which the metadata is to be associated. In such an embodiment, the outline is preferably formed using tools such as a stylus or touch screen and the shape could be open or closed.

The user selects the portion of the image to which the graphical element applies, via step 114. The size and position of the graphical element are set in step 114. Step 114 may be performed using the navigation buttons 138 to increase or decrease the size of the graphical element and to move the graphical element through portions of the image depicted on the display 136. The navigation buttons 138 may also be used to outline the portion of the image with which the metadata is to be associated. Alternatively, a joystick, touch screen, or other mechanism (not shown) might be used.

The metadata is entered, via step 116. The metadata might be text entered from the user interface 132, for example using a keypad (not shown), by selecting characters from a screen, or by writing using a stylus. The metadata might also include sound which the user records or other data. Note that the metadata may be entered prior to the graphical element being selected in step 112. The metadata is associated with the portion of the image and thus the graphical element, via step 118. In one embodiment, step 118 includes allowing the user to attach the metadata to the graphical element (and the corresponding portion of the image) that has been set in steps 112 and 114. In another embodiment, the metadata entered in step 116 is automatically associated with the portion of the image defined using the graphical element provided in steps 112 and 114. Step 118 also includes storing the metadata such that the metadata corresponds to the appropriate portion of the image. In one embodiment, step 118 includes storing the metadata, or a tag pointing to the metadata, with the x and y-coordinates of the portion of the image defined by the graphical element described in steps 112 and 114. Step 118 might also include converting the metadata to another format, such as html. The metadata and other information may optionally be used in other operations, via step 120. For example, the metadata might be used to index the associated image in a library. A search of the library for the metadata would result in the shapes set in steps 112 and 114 being returned. In one embodiment, the associated image might also be returned. The metadata might also be catalogued based on the creator of the metadata. Consequently, a particular image may be passed to different users, each of whom can use the method 110 to associate metadata with a particular portion of the image. Viewers of the image might not only be able to view the metadata, but also determine who created the metadata.

Thus, using the method 110, metadata may be associated with particular portions of an image. The collectively, the metadata associated with portions of the image along with any metadata associated with the image in its entirety make up the metadata for the image. As a result, a user is better able to describe elements within an image in addition to the whole image. Furthermore, characteristics of the metadata, such as the associated image, the shape of the portion of the image with which the metadata is associated, and the creator of the metadata may also be employed to aid and inform users.

FIG. 5 is a flow chart depicting one embodiment of a method 150 in accordance with the present invention for displaying an image having metadata associated with a portion of the image. The method 150 is preferably employed for an image having metadata associated using the method 100 and/or 110. In addition, the method 150 may be implemented on a variety of systems. In one embodiment, the method 150 is implemented using an image capture device such as a digital camera. The method 150 may be performed on another device, such as a computer system.

The image is displayed in a desired status, via step 152. In one embodiment, the desired state can either be with the portions of the image to which metadata corresponds highlighted or with the portions of the image un-highlighted. In one embodiment, a user can choose how the image is desired to be displayed and toggle between the views. In one embodiment, some or all of the portions of the image associated with metadata may be highlighted or otherwise displayed so that the viewer is informed of the existence of the metadata. Thus, the user is allowed to switch between the portions of the image being highlighted and not highlighted, via step 154. The viewer is allowed to select portions of the image to which the metadata corresponds in order to view the metadata, via step 156. In one embodiment, step 156 simply includes allowing the viewer to move a cursor or pointer from a mouse or the point of a stylus, over a section of one portion of the image with which metadata is associated. In response to the selection of a portion of the image, the metadata is played, via step 158. Thus, the text in the metadata pops up or the sound is played. In addition, the user is allowed to search based on the metadata, via step 160. Thus, a search can be performed for images, shapes, and/or creators of the metadata that may be indexed by the metadata. In addition, the image is allowed to be printed, via step 162. The image can be printed in step 162 with or without the metadata. The image may also be printed with or without the portions of the image to which the metadata correspond highlighted. Finally, the viewer may be able to add metadata that corresponds to portions of the image, via step 164. Step 164 preferably implements the method 100 or 110. After steps 158, 160, 162, and 164, step 152 may be returned to.

Thus, using the method 150, a viewer of the image can be better informed of the contents of the image through the metadata. Moreover, the viewer can add to the description of specific portions of the image. Finally, the viewer can also discover other images or additional information related to the image or metadata.

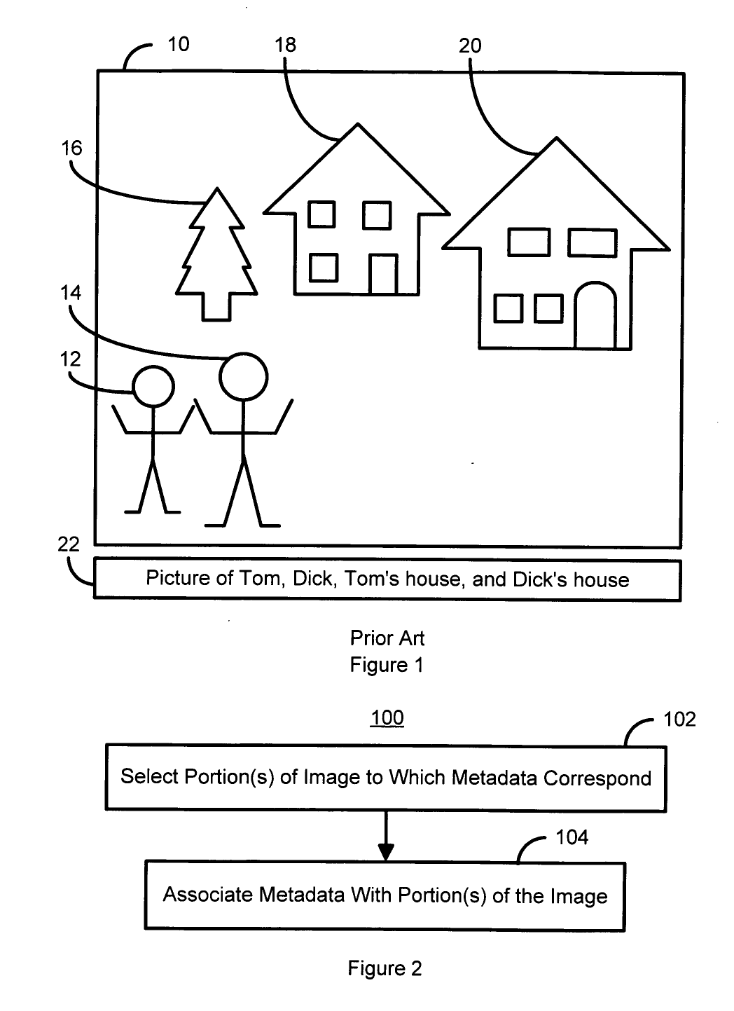

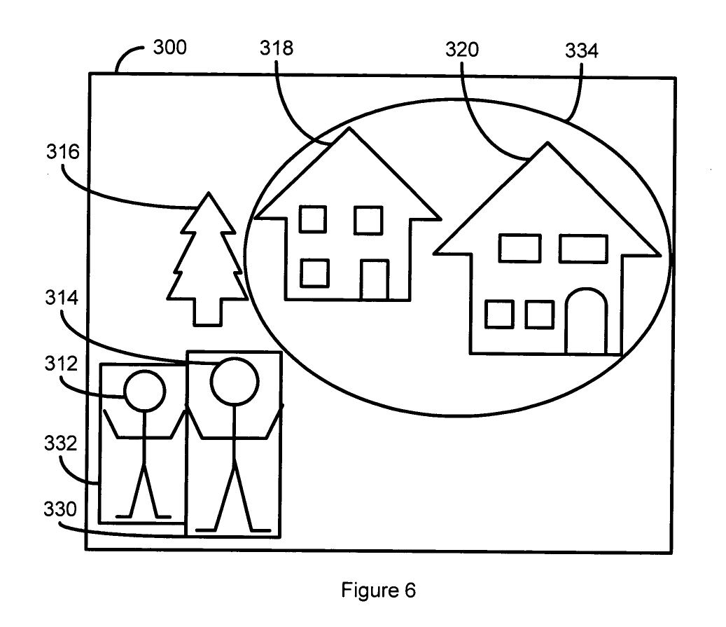

FIG. 6 is a diagram of one embodiment of an image 300 in accordance with the present invention having metadata associated with portions of the image and having all portions of the image corresponding to the metadata highlighted. The image includes elements 312, 314, 316, 318, and 320 that correspond to the elements 12, 14, 16, 18, and 20, respectively, of the conventional image 10 depicted in FIG. 1. Referring back to FIG. 6, the portions 330, 332, and 334 of the image corresponding to metadata (not shown in FIG. 6), are highlighted. Although depicted as being outlined, other mechanisms for highlighting the portions 330, 332, and 334 could be used. For example, the portions 330, 332, and 334 might be dimmed or made slightly opaque. Thus, the user can be informed of the existence of metadata associated with portions of the image.

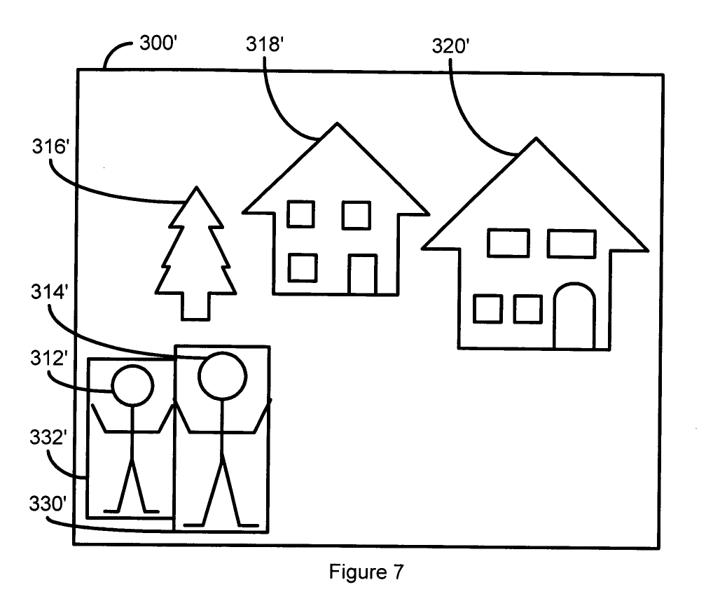

FIG. 7 is a diagram of one embodiment of an image 300′ in accordance with the present invention having metadata associated with portions of the image and having some of the portions corresponding to the metadata highlighted. The image 300′ corresponds to the image 300. Consequently, portions of the image 300′ corresponding to the image 300 are labeled similarly. Thus, the image 300′ includes elements 312′, 314′, 316′, 318′, and 320′. In addition, only the portions 330′ and 332′ are highlighted. Thus, selected portions of the image, here the people 312′ and 314′, are highlighted.

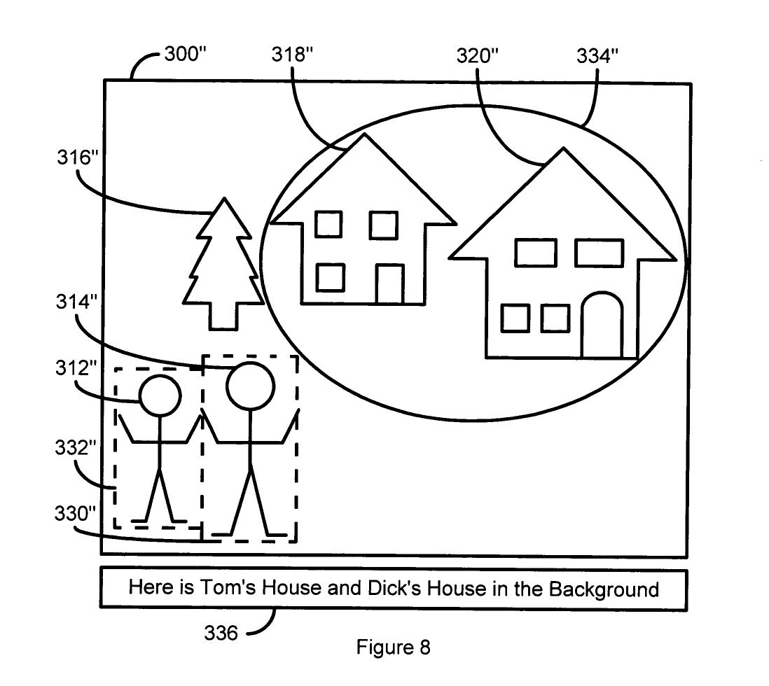

FIG. 8 is a diagram of one embodiment of an image 300″ in accordance with the present invention having metadata associated with a portion of the image selected and the associated metadata displayed. The image 300″ corresponds to the image 300. Consequently, portions of the image 300″ corresponding to the image 300 are labeled similarly. Thus, the image 300″ includes elements 312″, 314″, 316″, 318″, and 320″. The portions 330″, 332″, and 334″ are highlighted as including metadata. In addition, the portions 334″ is selected (thus being highlighted with a solid line) and the corresponding metadata 336 displayed.

Thus, a viewer of the image 300, 300′, and 300″ can discover additional information about portions of the image 300, 300′, and 300″, can add to the metadata, or otherwise be better informed of the contents of the image 300, 300′, and 300″.

A method and system for associating metadata with a portion of an image has been disclosed. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

We claim:

1. A method for associating metadata with an image comprising;
allowing a portion of the image to be selected;
associating the metadata with the portion of the image.

2. The method of claim 1 further including:
allowing data related to the portion of the image or the metadata to be entered to a digital imaging device.

3. The method of claim 1 wherein the allowing step further includes:
allowing a graphical element to be selected; and
associating the portion of the image with the graphical element.

4. The method of claim 3 wherein the graphical element is a shape and wherein the step of allowing the graphical element to be selected further includes:
allowing the shape to selected.

5. The method of claim 4 wherein the shape is an oval.

6. The method of claim 4 wherein the shape is a rectangle.

7. The method of claim 3 wherein the graphical element selecting step further includes the step of:
allowing the portion of the image to be outlined.

8. The method of claim 1 wherein the portion includes at least one object and wherein the allowing step further includes:
allowing the at least one object to be selected; and wherein the associating step further includes
associating the metadata with the at least one object.

9. The method of claim 1 wherein the portion is associated with at least one x-coordinate and at least one y-coordinate and wherein the associating step further includes:
associating metadata with the at least one x-coordinate and the at least one y-coordinate of the portion of the image.

10. The method of claim 1 further comprising:
associating the metadata with the portion of the image such that passing a cursor or pointer over the portion of the image plays the metadata.

11. The method of claim 1 further comprising:
associating the metadata with the portion of the image such that the portion of the image such that the portion of the image is highlighted.

12. The method of claim 11 wherein the highlighting of the portion of the image can be toggled on or off.

13. The method of claim 1 wherein the metadata can be used to index the image.

14. The method of claim 1 wherein the metadata is associated with a particular user.

15. A method for associating metadata with an image comprising;
allowing a portion of the image to be selected, the portion of the image being corresponding to at least one x-coordinate and at least one y-coordinate;
associating the metadata with the portion of the image by associating metadata with the at least one x-coordinate and the at least one y-coordinate of the portion of the image; and
highlighting the portion of the image.

16. A method for viewing an image, metadata being associated with the image, the method comprising:
displaying the image with a portion of the image being highlighted, the metadata being associated with the portion of the image;
allowing the metadata to be played in response to the portion of the image being selected.

17. The method of claim 16 further comprising:
allowing the image to be displayed without the portion of the image being highlighted.

18. The method of claim 16 further comprising:
indexing information based upon the metadata.

19. The method of claim 18 further comprising:
allowing a search based upon the metadata; and
returning the information, if any, in response to the search.

20. The method of claim 16 further comprising:
allowing the image to be printed with the metadata displayed.

21. The method of claim 16 further comprising:
allowing the image to be printed without the portion being highlighted.

22. A computer-readable medium containing a program for associating metadata with an image, the program including instructions for:
allowing a portion of the image to be selected;
associating the metadata with the portion of the image.

23. The computer-readable medium of claim 22 wherein the program further includes:
allowing data related to the portion of the image or the metadata to be entered to a digital imaging device.

24. The computer-readable medium of claim 22 wherein the allowing instructions further includes:
allowing a graphical element to be selected; and
associating the portion of the image with the graphical element.

25. The computer-readable medium of claim 24 wherein the graphical element is a shape and wherein the instructions for allowing the graphical element to be selected further include:
allowing the shape to selected.

26. The computer-readable medium of claim 25 wherein the shape is an oval.

27. The computer-readable medium of claim 25 wherein the shape is a rectangle.

28. The computer-readable medium of claim 24 wherein the graphical element selecting instructions further includes instructions for:
allowing the portion of the image to be outlined.

29. The computer-readable medium of claim 24 wherein the portion includes at least one object and wherein the allowing instructions further includes:
allowing the at least one object to be selected; and wherein the associating step further includes
associating the metadata with the at least one object.

30. The computer-readable medium of claim 22 wherein the portion is associated with at least one x-coordinate and at least one y-coordinate and wherein the associating instructions further include:
associating metadata with the at least one x-coordinate and the at least one y-coordinate of the portion of the image.

31. The computer-readable medium of claim 22 wherein the program further includes instructions for:
associating the metadata with the portion of the image such that passing a cursor or pointer over the portion of the image plays the metadata.

32. The computer-readable medium of claim 22 wherein the program further includes instructions for:
associating the metadata with the portion of the image such that the portion of the image such that the portion of the image is highlighted.

33. The computer-readable medium of claim 22 wherein the highlighting of the portion of the image can be toggled on or off.

34. The computer-readable medium of claim 22 wherein the metadata can be used to index the image.

35. The computer-readable medium of claim 22 wherein the metadata is associated with a particular user.

36. A computer-readable medium containing a program for associating metadata with an image, the program including instructions for:
allowing a portion of the image to be selected, the portion of the image being corresponding to at least one x-coordinate and at least one y-coordinate;
associating the metadata with the portion of the image by associating metadata with the at least one x-coordinate and the at least one y-coordinate of the portion of the image; and
highlighting the portion of the image.

37. A computer-readable medium containing a program for viewing an image, metadata being associated with the image, the program including instructions for:
displaying the image with a portion of the image being highlighted, the metadata being associated with the portion of the image;
allowing the metadata to be played in response to the portion of the image being selected.

38. The computer-readable medium of claim 37 wherein the program further includes instructions for:
allowing the image to be displayed without the portion of the image being highlighted.

39. The computer-readable medium of claim 37 wherein the program further includes instructions for:
indexing information based upon the metadata.

40. The computer-readable medium of claim 39 wherein the program further includes instructions for:
allowing a search based upon the metadata; and
returning the information, if any, in response to the search.

41. The computer-readable medium of claim 37 wherein the program further includes instructions for:
allowing the image to be printed with the metadata displayed.

42. The computer-readable medium of claim 37 wherein the program further includes instructions for:
allowing the image to be printed without the portion being highlighted.

43. A digital imaging device for capturing an image comprising:
a user interface for navigating around the image and allowing a portion of the image to be selected; and
a selector tool for associating metadata with the portion of the image;
